(19) United States
(12) Patent Application Publication
(10) Pub. No.: US 2025/0374934 A1
(43) Pub. Date: Dec. 11, 2025

(54) NON-ALKALIZED BOILED COCOA POWDER

(71) Applicant: SOCIETE DES PRODUITS NESTLE S.A., Vevey (CH)

(72) Inventors: AURELIEN COTARD, Saviese (CH); PHILIPPE DEFFERRARD, Severy (CH); ISABEL PELLON VEGA HAZAS, Santander (ES); NOEMIE ROSANNE AUZANNEAU, Orbe (CH)

(21) Appl. No.: 18/877,660

(22) PCT Filed: Jun. 20, 2023
(86) PCT No.: PCT/EP2023/066621

§ 371 Date: Dec. 20, 2024

(30) Foreign Application Priority Data
Jun. 23, 2022 (EP) 22180773.8

(51) Int. Cl. A23G 1/46; A23G 1/00; A23G 1/56

(52) U.S. Cl. CPC A23G 1/46; A23G 1/002; A23G 1/56

(57) ABSTRACT

The present invention relates to relates to a non-alkalized, boiled and roasted cocoa solids comprising below 0.14 wt. % of caffeine and below 1.2 wt. % theobromine, preferably below 0.9 wt. % theobromine. The invention also relates to cocoa beverage liquid and powder with these characteristics. Furthermore, the invention relates to a method of making non-alkalized, boiled and roasted cocoa solids, the method comprising: providing cocoa nibs, boiling the cocoa nibs under pressure at a pressure of 1.5-4 bar for a period of 10-60 min, filtering the boiled cocoa nibs to a moisture content of 30-80 wt. %, preferably 50-75 wt. %, roasting the boiled nibs to a moisture content below 4 wt. % and grinding the roasted nibs to provide cocoa liquor, pressing to obtain a cocoa cake, preferably having a fat level 10-12 wt. % or 20-22 wt. % fat, and grinding the cocoa cake to cocoa solid.

### FIELD OF THE INVENTION

The present invention relates to non-alkalized cocoa solids and powders, in particular to cocoa solids and powders with low levels of caffeine and theobromine. The invention also relates to a method of making such non-alkalized cocoa solids.

### BACKGROUND

Cocoa powders are in general bitter by nature. When used in children's beverages, the cocoa is often compensated with the use of sweetener solutions to achieve acceptable taste.

Flavoring may be used to modulate the overall flavor of the beverage, but flavors may sometimes be considered as artificial.

JP2018085947 discloses a method for producing chocolate confectionery containing cocoa nibs and corresponding sweeteners as main raw materials, the method comprising the steps of: preparing a chocolate confectionery containing, as main raw materials, 35% of a total amount of cocoa nibs in the raw material, coarse particle cocoa nibs ground mainly to a size of not greater than 1.5 mm and not less than 0.4 mm, and fine particle cocoa nibs ground mainly to a size of not greater than 0.4 mm. Also disclosed is a method of manufacturing a chocolate confectionery having an aspiration sensation similar to tobacco, the method comprising mixing an appropriate amount of the raw material sweetener, boiling the raw material while stirring, dissolving a portion of the cocoa nib, placing the cocoa nib in a rod-like mold, cooling and solidifying the mixture, baking the mixture, cooling and then drying the mixture.

JP2016106559 discloses a method wherein roux is boiled in edible oils and fats, with wheat flour. Disclosed is also cacao bean-derived component, in which the cacao bean-derived component includes cacao mass, and/or cocoa powder. The aim of the process is to enhance flavors.

The prior art relates to cocoa treatment aimed at producing new cocoa-based product with new sensory characteristics. None of prior art documents apply an extraction step allowing separation of undesired compounds like bitter compounds.

In most cases, alkalisation is done on the cocoa nibs before roasting: nibs are added to a jacketed tank fitted with a mixing device and the ability to vary air flow. An aqueous alkalisation solution (eg. potassium carbonate) is added to the nibs and the temperature/air flow/pressure is varied to get different colours/flavours. At the end of the process any excess alkalisation solution can be drained away and the residual moisture remaining on the nibs is removed in the nib roaster (via an initial ‘drying’ phase of the roasting profile).

Alkalization is an established process to create cocoa powder with darker colors and desired taste profile. However, the use of chemical components, alkali salts, might not be desired by consumers looking for more natural products.

Thus, there is a need for tailoring the flavor generation during cocoa processing. Furthermore, there is a need to reduce or mask undesirable notes of the cocoa powder and/or create new flavors. In particular, it is desirable to reduce or eliminate the amount of sweeteners and/or flavorings in the final product.

### OBJECT OF THE INVENTION

The objective of the present invention is to improve the state of the art and in particular to provide non-alkalized cocoa solids, powder, liquid cocoa beverages and nibs with an improved flavour profile that allows low sugar formulations.

### SUMMARY OF THE INVENTION

The present invention provides the improvement by the subject matter of the independent claims. The dependent claims further develop the idea of the present invention.

In a first aspect, the invention relates to a non-alkalized, boiled and roasted cocoa solids comprising below 0.14 wt. % of caffeine and below 1.2 wt. % theobromine, preferably below 0.9 wt. % theobromine.

In a second aspect, the invention relates to a cocoa beverage powder comprising: 10-75 wt. % cocoa solids according to the invention, 0-35 wt. % non-fat milk solids, 0-2.0 wt. % vegetable oil and/or milk fat, 0-80% wt. % sucrose, and 0-50 wt. % cereal flour or extract.

In a further aspect, the invention relates to a method of making non-alkalized, boiled and roasted cocoa solids, the method comprising:
providing cocoa nibs,
boiling the cocoa nibs under pressure at a pressure of 1.5-4 bar for a period of 10-60 min,
filtering the boiled cocoa nibs to a moisture content of 30-80 wt. %, preferably 50-75 wt. %,
roasting the boiled nibs to a moisture content below 4 wt. % and
grinding the roasted nibs to provide cocoa liquor,
pressing to obtain a cocoa cake, preferably having a fat level 10-12 wt. % or 20-22 wt. % fat, and
grinding the cocoa cake to cocoa solid.

It has been found that the present invention provides new physical and sensory properties of cocoa. The invention provides cocoa solids with reduced bitterness due to the partial removal of main cocoa bitter compounds theobromine and caffeine. Besides taste modulation, a new process allows a darkening of the cocoa solids compared to a classic natural cocoa processing. Formulated in a cocoa beverage or food solid, the low bitterness of the cocoa solids according to the invention allows a significant sugar reduction as there is no need to cover the intrinsic bitterness with sugar.

The present invention allows to modulate the flavor of cocoa products such as cocoa liquor, powder and butter and create unique flavor signatures (caramel, biscuity, nutty, honey, etc.). The process may be suitable for the valorization of different qualities of cocoa making it more desirable with reduced bitterness and different sensory profile. Flavoured cocoa products may bring new business opportunities by enlarging a sensory space of cocoa-containing products using the non-alkalized, boiled and roasted cocoa solids.

Advantageously, the non-alkalized, boiled and roasted cocoa solids may help to reduce sugar in products (sugar often masks undesired cocoa flavours such as bitterness or earthiness).

This present invention enables to reach very low bitterness and acidity levels. These new sensory properties allow lowering the amount of sugars added in the final product for similar sweetness. In addition, this leads to a cocoa powder much darker than what can be achieved with a standard natural cocoa process.

In one embodiment of the invention, roasting can be omitted in the cocoa manufacturing. Omission of roasting can bring significant savings in equipment investment and would improve sustainability by saving the energy and water.

Although decaffeination is known in coffee production, the process is substantially different from the present invention due to the coffee batch brewing that takes place when producing coffee. In this process liquid is passed through the coffee material and caffeine may be removed by filtering the liquid to trap the caffeine. In cocoa processes the aim is to preserve the cocoa nibs for further processing.

### BRIEF DESCRIPTION OF THE DRAWINGS

FIG. 1 is a sensory Principal Component Analysis (PCA) mapping of original and treated cocoa with natural and alkalized commercial powders. In FIG. 1A shows alkalized cocoa powders and N shows natural cocoa powders.

FIG. 2 shows caffein in roasted cocoa compared to boiled and roasted cocoa.

FIG. 3 shows theobromine content in roasted cocoa compared to boiled and roasted cocoa.

FIG. 4 shows a sensory PCA mapping of chocolate beverages according to Table 2 containing original and treated cocoa.

FIG. 5 is a chart showing the impact of sugar reduction on bitterness perception using treated and untreated cocoa in chocolate beverages according to Table 3.

FIG. 6 shows pressure impact on caffeine in cocoa powders.

FIG. 7 shows pressure impact on theobromine in cocoa powders.

FIG. 8 shows pressure impact on fat in cocoa powders.

FIG. 9 shows pressure impact on cocoa powder color (L). ‘L’ is the lightness.

FIG. 10 shows pressure impact on cocoa powder color (A). ‘A’ represents the green/magenta chromatic axis.

FIG. 11 shows pressure impact on cocoa powder color (B). ‘B’ represents the blue/yellow chromatic axis.

FIG. 12 is a process flowchart of an embodiment of the method according to the invention.

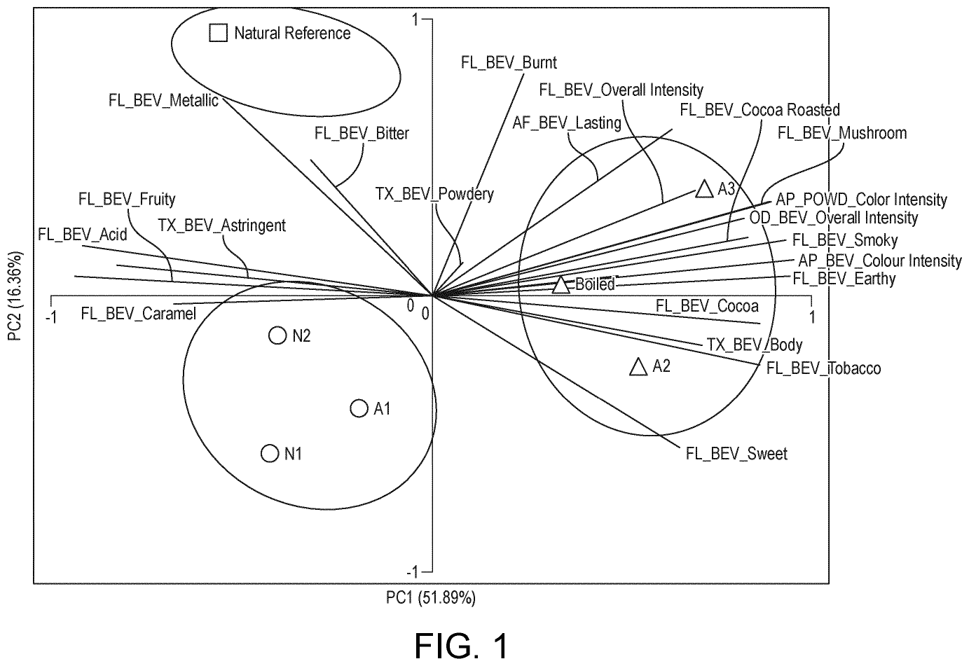

### DETAILED DESCRIPTION OF THE INVENTION

Consequently, the present invention relates to a non-alkalized, boiled and roasted cocoa solids comprise below 0.14 wt. % of caffeine and below 1.2 wt. % theobromine, preferably below 0.9 wt. % theobromine.

Preferably the non-alkalized, boiled and roasted cocoa solids comprise 0.05-0.14 wt. % caffeine and 0.5-1.2 wt. % theobromine.

In a further preferred embodiment of the invention the cocoa solids comprise 0.07-0.1 wt. % caffeine and 0.7-1.0 wt. % theobromine.

Commercial cocoas contain, on the average, 1.89% theobromine and 0.21% caffeine (Zoumas B. L., Kreiser W. R., Martin R. A, Theobromine and caffeine content of chocolate products. J. Food Sci. 1980; 45:314-316)

In a preferred embodiment of the invention the cocoa solids comprise 5-25 wt. %, preferably 10-12 wt. cocoa fat or 20-22 wt. %. In an alternative embodiment of the invention the non-alkalized, boiled and roasted cocoa nibs comprising 50-55 wt. % cocoa fat, below 0.14 wt. % of caffeine, and below 1.2 wt. % theobromine, preferably below 0.9 wt. % theobromine.

It has been found that the cocoa powder according to the invention has a color LAB min value of at least (43, 13, 20). This provides a desirable dark powder.

Preferably, the cocoa beverage powder according to the invention comprises 1 to 75 wt. % added sucrose.

In one embodiment of the invention the cocoa beverage powder comprises:
10-75 wt. % cocoa solids as described above,
0-35 wt. % non-fat milk solids,
0-2.0 wt. % vegetable oil and/or milk fat,
0-80% wt. % sucrose, and
0-50 wt. % cereal flour or extract.

In another embodiment of the invention the cocoa beverage powder comprises:
25-55 wt. % cocoa solids as described above,
20-35 wt. % non-fat milk solids,
0-2.0 wt. % vegetable oil and/or milk fat,
5-35 wt. % sucrose, and
5-35 wt. % cereal flour or extract.

The invention also relates to a liquid cocoa beverage product comprising:
1-5 wt. % non-alkalized, boiled and roasted cocoa solids according to the claims, 3-10 wt. % non-fat milk solids, and 0-5 wt. % sucrose.

This will result in a final product with below 0.007 wt. % of caffeine, and below 0.06 wt. % theobromine, preferably below 0.045 wt. %.

In a further embodiment the invention relates to a liquid cocoa beverage product comprising: 1-5 wt. % cocoa solids according to claims 1-4, 4-12 wt. % plant-based flour, and 0-7 wt. % sucrose.

This will result in a final product comprising below 0.007 wt. % of caffeine, and below 0.06 wt. % theobromine, preferably below 0.045 wt. %.

Alternatively, plant-based isolates or concentrates may be used instead of plant-based flour.

In a further aspect, the invention relates to a method of making non-alkalized, boiled and roasted cocoa solids, the method comprising:
providing cocoa nibs,
boiling the cocoa nibs under pressure at a pressure of 1.5-4 bar for a period of 10-60 min,
filtering the boiled cocoa nibs to a moisture content of 30-80 wt. %, preferably 50-75 wt. %,
roasting the boiled nibs to a moisture content below 4 wt. % and
grinding the roasted nibs to provide cocoa liquor,
pressing to obtain a cocoa cake, preferably having a fat level 10-12 wt. % or 20-22 wt. % fat, and
grinding the cocoa cake to cocoa solid.

Cocoa nibs treated with milder conditions, with lower pressure or temperature and shorter time than what is claimed results in cocoa solids product with limited reduced bitterness compared to commercially available products, and will not have the effect as that obtained with the cocoa solids described in the claims.

It is preferred that the boiling of the cocoa nibs is done for a period of 20-40 min, preferably from 30-35 min, at a pressure between 3-5 bars.

The method of the invention is a modified alkalization process. It comprises:
1. Optional step: Preparation of flavour infusion without alkali.
2. Boiling cocoa beans or nibs in the flavour infusion.
3. Filtration of the beans or nibs
4. Drying and roasting
5. Grinding
6. Processing of cocoa liquor

The steps may be taken as follows:

### Step 1: Preparation of Flavor Infusion (Optional).

An infusion is prepared by dissolution/dispersion of flavour ingredients in water under vigorous stirring. The mix is brought to boil for 15-30 minutes under low stirring and filtered in the case of infusion with solid ingredients.

Step 2: Boiling of the Beans or Nibs in Infusion without Alkali

The beans or nibs are added in a tank with the infusion or with water only and the mixture is boiled under pressure at a pressure of 1.5-4 bar for a period of 10-60 min. In the process according to the invention the cocoa nibs and water are added into a vessel, preferably a closed vessel. The water is not recirculated but remains in the vessel until the filtration of the beans or nibs.

### Step 3: Filtration

The fixture is filtered on a sieve to remove the excess of water. The filtering of the boiled cocoa nibs is to a moisture content of 30-80 wt. %, preferably 50-75 wt. %.

In the process according to the invention it is preferred that after water is removed in the filtering of the boiled cocoa nibs the water is disposed of. According to the invention it is preferred that there is no extraction in an extraction column with recirculation of water.

### Step 4: Drying and Roasting

Infused and boiled beans or nibs are then roasted using standard roasting profiles in a cocoa roaster established in cocoa manufacturing.

### Step 5-8: Grinding and Processing of Cocoa Liquor

Roasted cocoa (moisture below 4%, preferably below 3%) is ground and cocoa liquor is then obtained.

The roasted cocoa nibs are pressed to obtain a cocoa cake, preferably having a fat level 10-12 wt. % or 20-22 wt. % fat, and grinding the cocoa cake to cocoa solid.

The liquor might be directly used for further food manufacturing (e.g. chocolate production) or pressed to obtain cocoa powder and cocoa butter as finished products. The powder and the butter may then be used in the manufacturing of cocoa products.

Those skilled in the art will understand that they can freely combine all features of the present invention disclosed herein. In particular, features described for the product of the present invention may be combined with the use of the present invention and vice versa. Furthermore, features described for different embodiments of the present invention may be combined.

Although the invention has been described by way of example, it should be appreciated that variations and modifications may be made without departing from the scope of the invention as defined in the claims.

Furthermore, where known equivalents exist to specific features, such equivalents are incorporated as if specifically referred in this specification. Further advantages and features of the present invention are apparent from the figures and non-limiting examples.

### EXAMPLES

### Example 1

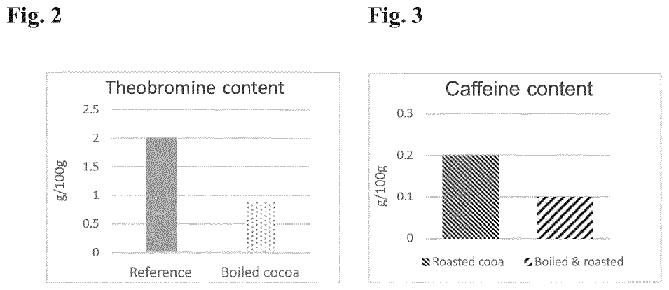

Table 1 and related FIGS. 2 and 3 show caffein and theobromine content in reference roasted cocoa compared to boiled and roasted cocoa. A clear reduction around 50% is observed between reference sample and the boiled cocoa.

TABLE 1
Reduction of main cocoa bitter compounds:
Theobromine & Caffeine

| | Caffeine | Theobromine |
|---|---|---|
| Sample | (g/100 g) | (g/100 g) |
| Boiled and roasted cocoa | 0.1 | 0.88 |
| Reference cocoa | 0.2 | 2.01 |

### Example 2—Application of the Invention in Chocolate Beverage

TABLE 2
Sample tested by panelists with treated/untreated cocoa
in a chocolate beverage application (explain preparation)

| Sugar | Sugar/ | Cocoa/ | total serving size/ |
|---|---|---|---|
| reduction % | serving (g) | serving (g) | 200 mL milk 1.5% fat |
| Reference | 10.11 | 3.15 | 13.26 |
| −25% sugar | 7.58 | 3.15 | 10.73 |
| −50% sugar | 5.06 | 3.15 | 8.20 |
| −63% sugar | 3.78 | 4.08 | 7.86 |

Different chocolate beverages were tasted while gradually reducing sugar. Samples were produced by dry mixing white sugar and cocoa powder (boiled or natural cocoa untreated) and then reconstituted in warm milk (55° C.) until complete dissolution of the powder. Samples were then evaluated by 12 trained panelists on established criteria for chocolate beverages as such as appearance, texture, odor, flavour and taste.

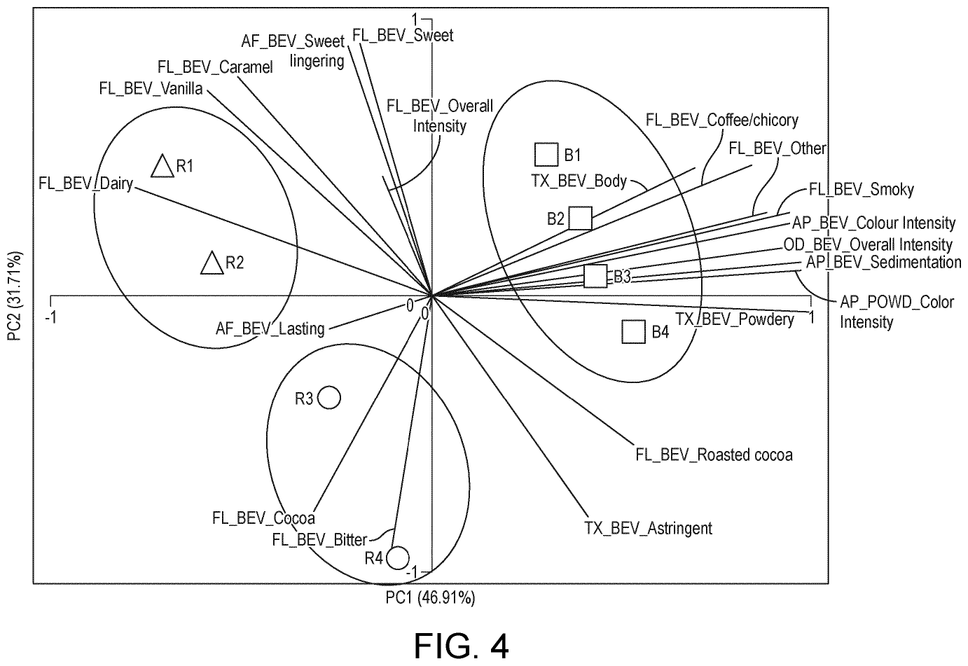

FIG. 4 shows a sensory PCA mapping of chocolate beverages according to Table 2 containing original and treated cocoa. In FIG. 4 the following products are shown:

| | |
|---|---|
| R1 | Reference beverage with classic natural cocoa powder |
| R2 | −25% sugar with classic natural cocoa powder |
| R3 | −50% sugar with classic natural cocoa powder |
| R4 | −63% sugar with classic natural cocoa powder |
| B1 | Reference beverage with boiled cocoa powder |
| B2 | −25% sugar with boiled cocoa powder |
| B3 | −50% sugar with boiled cocoa powder |
| B4 | −63% sugar with boiled cocoa powder |

A clear trend can be observed on the PCA analysis of evaluated chocolate beverage. Samples using boiled cocoa appear be less impacted by the sugar reduction. Only one sensory territory can be observed using the boiled cocoa at the different sugar levels.

An opposite impact is observed using untreated natural cocoa. Only a small effect is visible while reducing sugar by 25% with a same sensorial territory than the reference. However, as soon as the sugar reduction is higher (50 or 63%) a significant difference can be observed with powder landing in a new sensory territory mainly characterized by high bitterness and astringency as well as strong cocoa flavour.

### Example 3—Impact of Sugar Reduction on Bitterness

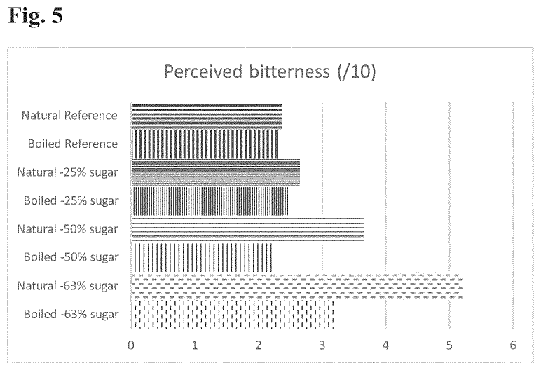

FIG. 5 is a chart showing the impact of sugar reduction on bitterness perception using treated on untreated cocoa in chocolate beverages according to Table 3.

The bitterness was found to be much lower in the sugar reduced application using boiled cocoa. Differences were increased while sugar was reduced. Benefit of boiled cocoa was significant while reducing sugar, especially at −50% reduction and above where products with boiled cocoa was found close to the reference (−50% sugar).

### Example 4—Impact of Process Parameters on Cocoa Properties

TABLE 3
Pressure impact on caffeine, theobromine and fat in cocoa powders

| | Caffeine | Theobromine | Fat content |
|---|---|---|---|
| Sample | (g/100 g) | (g/100 g) | (g/100 g) |
| Boiled nibs 0.1 bar | 0.18 | 1.8 | 14.86 |
| Boiled nibs 0.5 bar | 0.18 | 1.9 | 14.47 |
| Boiled nibs 1.5 bar | 0.16 | 1.51 | 15.25 |
| Boiled nibs 3 bar | 0.14 | 1.5 | 15.15 |

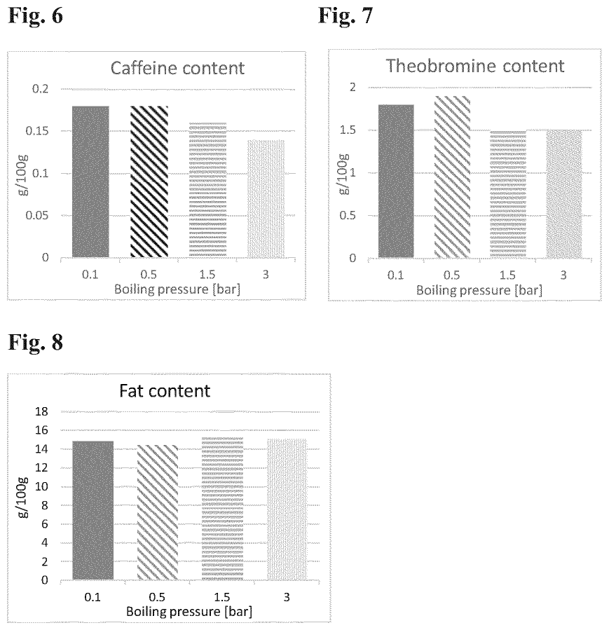

Table 3 and related FIGS. 6, 7 and 8 illustrate the impact of alkalizer pressure on the bitter compounds, caffeine and theobromine as well as on total fat content. Increasing pressure has a positive impact on caffeine and theobromine extraction with a significant decrease of both molecules. On the other hand, no significant impact was observed on the total fat level which remains stable.

### Example 5—Impact on Color

TABLE 4
Pressure impact on cocoa powder color (LAB scale)

| Sample | L | a | b |
|---|---|---|---|
| Boiled nibs 0.1 bar | 44.28 | 12.93 | 20.90 |
| Boiled nibs 0.5 bar | 44.27 | 12.91 | 20.51 |
| Boiled nibs 1.5 bar | 43.32 | 13.17 | 19.43 |
| Boiled nibs 3 bar | 40.64 | 13.43 | 18.59 |

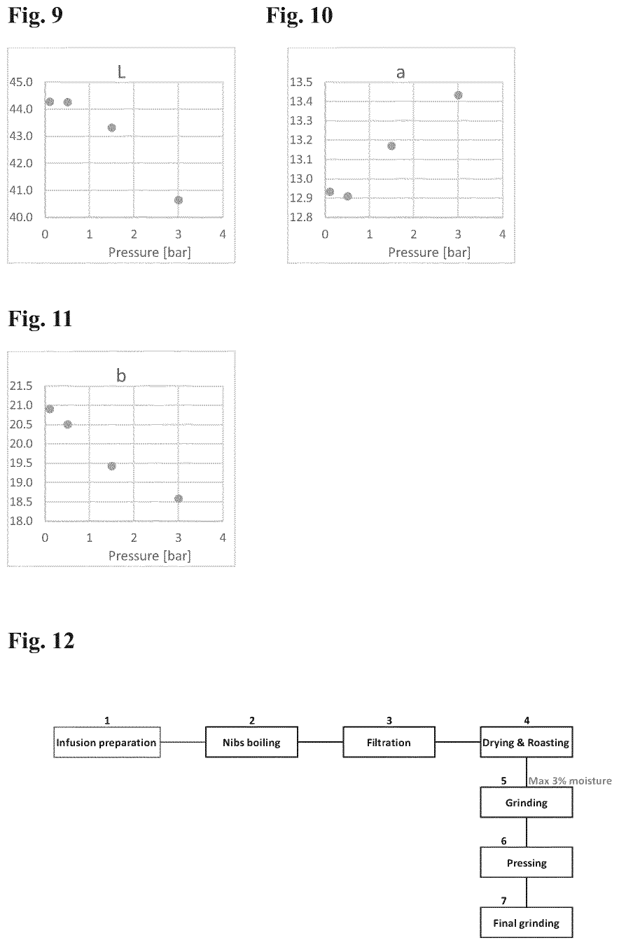

Table 4 and related FIGS. 9,10 and 11 show a darkening of the powder while the pressure in the alkalizer increased. Darker powder can be obtained increasing the pressure while boiling.

1. Non-alkalized, boiled and roasted cocoa solids comprising
less than 0.14 wt. % of caffeine and
less than 1.2 wt. % theobromine.

2. Non-alkalized, boiled and roasted cocoa solids according to claim 1 comprising 0.05-0.14 wt. % caffeine and 0.5-1.2 wt. % theobromine.

3. Cocoa solids according to claim 1, wherein the cocoa solids comprise 5-25 wt. %.

4. Cocoa solids according to claim 1, having a colour LAB min value of at least (43, 13, 20).

5. A cocoa beverage powder comprising
cocoa solids comprising
less than 0.14 wt. % of caffeine and
less than 1.2 wt. % theobromine, and
1-75 wt. % added sucrose.

6. A cocoa beverage powder according to claim 5 comprising:
10-75 wt. % cocoa solids,
0-35 wt. % non-fat milk solids,
0-2.0 wt. % vegetable oil and/or milk fat,
0-80% wt. % sucrose, and
0-50 wt. % cereal flour or extract.

7. A cocoa beverage powder according to claim 6 comprising:
25-55 wt. % cocoa solids,
20-35 wt. % non-fat milk solids,
0-2.0 wt. % vegetable oil and/or milk fat,
5-35 wt. % sucrose, and
5-35 wt. % cereal flour or extract.

8-10. (canceled)

11. A method of making non-alkalized, boiled and roasted cocoa solids, the method comprising:
providing cocoa nibs,
boiling the cocoa nibs under pressure at a pressure of 1.5-4 bar for a period of 10-60 min,
filtering the boiled cocoa nibs to a moisture content of 30-80 wt. %,
roasting the boiled nibs to a moisture content below 4 wt. % and
grinding the roasted nibs to provide cocoa liquor,
pressing to obtain a cocoa cake, preferably having a fat level 10-12 wt. % or 20-22 wt. % fat, and
grinding the cocoa cake to cocoa solid.

12. A method according to claim 11, wherein the boiling of the cocoa nibs is done for a period of 20-40 min.

13. A method according to claim 11, wherein the roasting is at 120-130° C. for 10 to 15 min.

14. A method according to claim 11, wherein the cocoa nibs and water are added into a vessel, preferably a closed vessel.

15. A method according to claim 11, wherein water removed in the filtering of the boiled cocoa nibs is disposed of.
